(19) United States
(12) Patent Application Publication
(10) Pub. No.: US 2009/0115344 A1
(43) Pub. Date: May 7, 2009

(54) LIGHTING APPARATUS DRIVEN BY COLOR COORDINATE SELECTION MODULE

(76) Inventors: Haing-Ju BAIK, GWANGJU (KR); Ki-Jun KIM, GWANGJU (KR); Jong-Sup KIM, GWANGJU (KR)

Correspondence Address: IPLA P.A., 3580 WILSHIRE BLVD., 17TH FLOOR, LOS ANGELES, CA, 90010, US

(21) Appl. No.: 12/172,060

(22) Filed: Jul. 11, 2008

(30) Foreign Application Priority Data
Nov. 7, 2007 (KR) 10-2007-0113431

(51) Int. Cl. H05B 37/02

(52) U.S. Cl. 315/291

(57) ABSTRACT

Provided is a lighting apparatus driven by a color coordinate selection module, which can emit color light corresponding to a chromaticity on a color coordinate, which is selected by a user. The lighting apparatus includes a chromaticity selection unit for providing a chromaticity and color temperatures so that a user can select the chromaticity and color temperatures, a light-emitting unit in which a plurality of light-emitting elements is arranged to selectively emit color light of different colors, a storage unit for storing driving pattern data of the light-emitting elements in response to the chromaticity and color temperatures that can be selected by the chromaticity selection unit, and a controller for controlling the driving of the light-emitting unit using the driving pattern data stored in the storage unit such that light of a chromaticity and color temperature selected by the chromaticity selection unit can be emitted.

### CROSS REFERENCES

Applicant claims foreign priority under Paris Convention and 35 U.S.C. §119 to Korean Patent Application No. 10-2007-0113431, filed Nov. 7, 2007 with the Korean Intellectual Property Office.

### BACKGROUND OF THE INVENTION

1. Field of the Invention

The present invention relates to a lighting apparatus and, more particularly, to a lighting apparatus driven by a color coordinate selection module, which can emit color light corresponding to a chromaticity on a color coordinate, which is selected by a user.

2. Background of the Related Art

A lighting apparatus basically provides light in order for a person to obtain visual information.

Most lighting apparatuses have functions of lighting up the dark and making things recognized and a structure in which the visual decoration effect of things is considered.

A human being's recognition of surrounding environments is very dependent on surrounding lightings, and a human being feels tired or comfortable according to the stimulus of his eyes from the intensity, color, chromaticity, etc. of a lighting. The visual sensitivity of a human being can vary according to articles that are visually recognized, for example, the value of a displayed product or side dishes on the dinner table.

In consideration of the visual stimulus effect of this lighting, there has recently been provided a lighting apparatus, which can change the quantity of light, if necessary, as well as the function of lighting up the dark or providing simple visual information. However, a conventional lighting apparatus whose amount of light is variable is constructed to change only the intensity of illumination through the control of electric power supplied to a light source. Thus, a user manipulates the conventional lighting apparatus experimentally in a state where illumination results obtained by changing the intensity of illumination cannot be expected, making it difficult to reproduce illumination light of a desired atmosphere accurately. In particular, in the case of lightings that produce atmospheres through the change of various colors and chromaticity, users cannot feel sympathy through reproducibility by users' manipulation, standardization of information about illumination light, sharing of information, and so on.

Further, the conventional lighting apparatus is adapted to illuminate colors variably, but not to select color temperatures and chromaticity in various ways or does not provide information about a color temperature of a selected illumination light and information about chromaticity, resulting in a degradation of accuracy and reproducibility in illumination light. Thus, the conventional lighting apparatus cannot increase, supply and share an experimental recognition ability of an illumination color sense corresponding to values of various color temperatures and chromaticity. Accordingly, the conventional lighting apparatus is problematic in that a user cannot easily perform production with respect to various color temperatures and chromaticity through lighting.

### SUMMARY OF THE INVENTION

Accordingly, the present invention has been made in an effort to solve the above problems occurring in the prior art, and it is an object of the present invention to provide a lighting apparatus, which can provide information about a chromaticity and color temperatures on the color coordinates and provide illumination light with a color and a color temperature corresponding selected color coordinates.

To achieve the above object, according to the present invention, there is provided a lighting apparatus, including a chromaticity selection unit for providing a chromaticity and color temperatures so that a user can select the chromaticity and color temperatures; a light-emitting unit in which a plurality of light-emitting elements is arranged to selectively emit color light of different colors; a storage unit for storing driving pattern data of the light-emitting elements in response to the chromaticity and color temperatures that can be selected by the chromaticity selection unit; and a controller for controlling the driving of the light-emitting unit using the driving pattern data stored in the storage unit such that light of a chromaticity and color temperature selected by the chromaticity selection unit can be emitted.

The chromaticity selection unit includes a display unit for displaying a chromaticity diagram for setting the color temperatures and the chromaticity on a screen such that a user can select color coordinate values on the chromaticity diagram, and an input unit for inputting the color coordinate values on the display unit and outputting input color coordinate values to the controller.

Preferably, the chromaticity selection unit includes a touch screen in which a display unit and an input unit are integrated.

The light-emitting unit preferably includes red, green, and blue light-emitting diodes.

The controller preferably includes a control unit for extracting driving pattern data corresponding to a chromaticity and a color temperature, which are selected by the chromaticity selection unit, from the storage unit, and a driver unit for controlling a light-emitting duty of a corresponding light-emitting element based on the driving pattern data output from the control unit.

### BRIEF DESCRIPTION OF THE DRAWINGS

Further objects and advantages of the invention can be more fully understood from the following detailed description taken in conjunction with the accompanying drawings in which:

FIG. 1 is a block diagram showing a lighting apparatus in accordance with the present invention;

FIG. 2 shows a chromaticity diagram provided through a screen of a chromaticity selection unit shown in FIG. 1; and

FIG. 3 is a circuit diagram showing an example of a driver unit shown in FIG. 1.

### DETAILED DESCRIPTION OF THE PREFERRED EMBODIMENT

The present invention will now be described in detail in connection with specific embodiments with reference to the accompanying drawings.

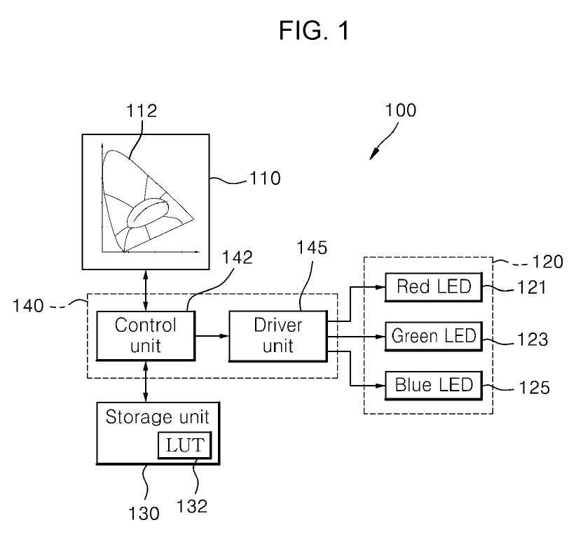

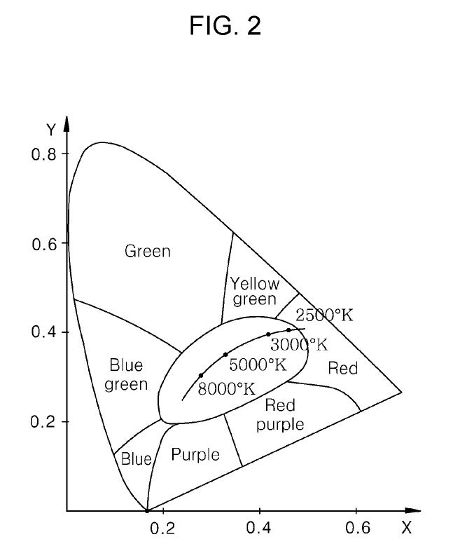

FIG. 1 is a block diagram showing a lighting apparatus in accordance with the present invention, and FIG. 2 shows a chromaticity diagram provided through a screen of a chromaticity selection unit shown in FIG. 1.

Referring to FIGS. 1 and 2, a lighting apparatus 100 includes a chromaticity selection unit 110, a light-emitting unit 120, a storage unit 130, and a controller 140.

The chromaticity selection unit 110 is adapted to allow a user to select color temperatures and chromaticity.

The chromaticity selection unit 110 is comprised of a display unit that provides a chromaticity diagram 112, that is, a color coordinate screen on which a user can select a color coordinate value corresponding to a color temperature and color, and an input unit for inputting coordinate values on the chromaticity diagram 112 provided on the display unit. Here, coordinate values input through the input unit are transmitted to the controller 140.

The chromaticity selection unit 110 can employ a touch screen in which the display unit for displaying the chromaticity diagram 112 for setting a color temperature and color, as shown in FIG. 2, on a screen so that a user can select color coordinate values on the chromaticity diagram 112, and the input unit for, when a coordinate value on the chromaticity diagram provided on the display unit is selected, outputting the selected coordinate value to the controller 140 are integrated.

However, it is noted that the chromaticity selection unit 110 may also employ an input unit in which, when a user moves a cursor and presses a setting key within a screen of a display unit for displaying the chromaticity diagram, a corresponding color coordinate value is output to the controller 140.

Here, the color temperature refers to a temperature of light by full heat radiation. If heat is applied to a black body at the absolute temperature of 0 degree (−273 degrees Celsius), that is, the lowest temperature, radiant wave is generated, and what the property of a light source at this time is represented by the unit of the absolute temperature is the color temperature the unit of which is Kelvin. As the color temperature becomes high, color changes from red color to orange color, yellow color, white color, and blue color.

Further, a color coordinate system refers to a coordinate system according to a color model for displaying color. The color model includes the RGB model, the HSB/HLS model, the Munsell color system and the CIE color model. Of them, the CIE model was defined by the International Commission on Illumination that sets standards for all things related to lighting. Representative CIE color models include CIE XYZ and CIE xyY. FIG. 2 shows the chromaticity diagram of the CIE color model.

The chromaticity diagram preferably also provides color of corresponding color coordinates such that a user can visually distinguish the color within the coordinates.

The chromaticity diagram may also be provided in a different form from that shown in the drawing. For example, a chromaticity every color, which can be selected by a user, can be divided into a square or octagon, corresponding colors can be displayed in the divided areas, and chromaticity or color temperature information are written.

The light-emitting unit 120 is a light-emitting element that can selectively emit color light of different colors, and has a number of light-emitting diodes 121, 123, and 125 arranged therein.

In the shown example, the light-emitting unit 120 employs red (R), green (G), and blue (B) light-emitting diodes 121, 123, and 125. In order to increase color rendering, a light-emitting diode that emits light of yellow green color or blue green color using phosphor, such as YAG, may also be used.

The number of light sources, which are used in the same color of the light-emitting unit 120, for example, the number of the red light-emitting diode 121 can be properly changed according to a lighting apparatus used. Further, a ratio in which the light-emitting diodes 121,123, and 125 of different colors are combined can be set to a ratio that can implement white light through mutual color mixing.

The storage unit 130 stores color coordinate values, which can be selected by the chromaticity selection unit 110, and corresponding driving pattern data of the light-emitting diodes 121, 123, and 125, which are used to generate color light of color temperatures. Reference numeral 132 denotes a look-up table (LUT) in which driving pattern data corresponding to color coordinate values are stored.

Here, the driving pattern data can include light-emitting duty values of the light-emitting diodes 121, 123, and 125, each corresponding to color coordinate values regarding a chromaticity and color temperatures.

Further, the driving pattern data can be divided and classified every color coordinate value ranges, which are divided into areas in which a chromaticity and color temperatures can be represented by the light-emitting unit 120, on the chromaticity diagram 112. Thus, the control unit 140 drives the light-emitting unit 120 using driving pattern data to which a color coordinate value selected by a user belongs.

Further, the driving pattern data can include light-emitting output values of respective light-emitting elements corresponding to a chromaticity and color temperatures. In this case, the controller 140 can be constructed to drive the light-emitting elements according to light-emitting output values.

The controller 140 controls driving of the light-emitting unit 120 using the driving pattern data stored in the storage unit 130 such that light of a color and a chromaticity, corresponding to a color coordinate value selected by the chromaticity selection unit 110, is emitted.

The controller 140 includes a control unit 142 and a driver unit 145. The control unit 142 extracts driving pattern data, corresponding to a color coordinate value selected by the chromaticity selection unit 110, from the storage unit 130. The driver unit 145 drives the light-emitting diodes 121, 123, and 125 according to a corresponding color-based light-emitting duty based on the driving pattern data output from the control unit 142.

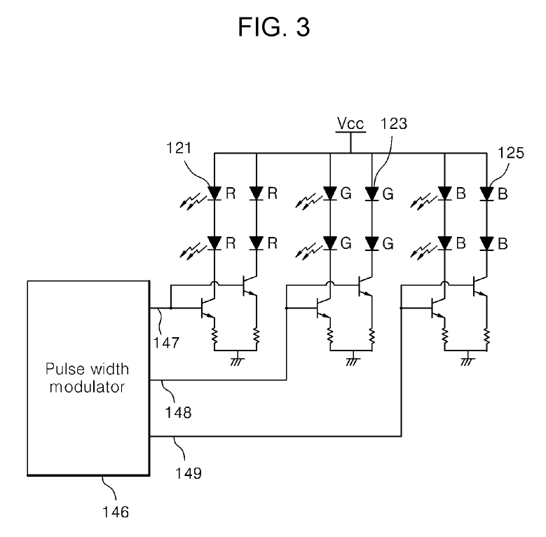

For example, the driver unit 145 can include, as shown in FIG. 3, a pulse width modulator 146, and switching elements. The switching elements switch on or off the supply of current to the light-emitting diodes 121, 123, and 125 according to signals output through output lines 147, 148, and 149 that are independently provided from the pulse width modulator 146 every colors.

As an example of controlling a color and color temperature through change of the light-emitting duty by this controller 140, in the case where a color temperature of 3000K is selected so as to provide white light, when the light-emitting duty of the red light-emitting diode 121 is set to 100%, the light-emitting duty of the green light-emitting diode 123 is set to 90%, and the light-emitting duty of the blue light-emitting diode 125 is set to 85%, the control unit 140 controls the red light-emitting diode 121 to consecutively drive such that an on-drive time where the red light-emitting diode 121 is light emitted on for a set period is 100%, controls the green light-emitting diode 123 to intermittently drive such that an on-drive time where the green light-emitting diode 123 is light emitted on for a set period is 90%, and controls the blue light-emitting diode 125 to intermittently drive such that an on-drive time where the blue light-emitting diode 125 is light emitted on for a set period is 85%.

As another example of the driving pattern data, in the case where color coordinates to select white light having a color temperature of 6000K are selected, the light-emitting duty of the red light-emitting diode 121 can be set to 97%, the light-emitting duty of the green light-emitting diode 123 can be set to 91%, and the light-emitting duty of the blue light-emitting diode 125 can be set to 92%. Alternatively, in the case where color coordinates to select white light having a color temperature of 9000K are selected, the light-emitting duty of the red light-emitting diode 121 can be set to 92%, the light-emitting duty of the green light-emitting diode 123 can be set to 90%, and the light-emitting duty of the blue light-emitting diode 125 can be set to 99%.

As described above, a user can select light of a desired color temperature and color on the color coordinates provided through the display screen of the chromaticity selection unit 110 and can be provided with corresponding illumination light from the light-emitting unit 120. Thus, a user can have increased numerical understanding of a chromaticity and color temperatures and experience a visual sense from corresponding illumination light. Accordingly, a user can be provided with convenience in controlling illumination environment corresponding to a chromaticity and color temperature values.

In accordance with the lighting apparatus according to the present invention, information about a chromaticity and color temperatures is provided to a user so that the user can select the information, and illumination light corresponding to a selected color coordinate value can be output in various ways. Accordingly, the present invention is advantageous in that a user can have increased convenience in producing various illumination environments according to surrounding environments, the intensity of illumination and/or a psychological state and can reproduce and share the various illumination environments.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A lighting apparatus, comprising:
a chromaticity selection unit for providing a chromaticity and color temperatures so that a user can select the chromaticity and color temperatures;
a light-emitting unit in which a plurality of light-emitting elements is arranged to selectively emit color light of different colors;
a storage unit for storing driving pattern data of the light-emitting elements in response to the chromaticity and color temperatures that can be selected by the chromaticity selection unit; and
a controller for controlling the driving of the light-emitting unit using the driving pattern data stored in the storage unit such that light of a chromaticity and color temperature selected by the chromaticity selection unit can be emitted.

2. The lighting apparatus as claimed in claim 1, wherein the light-emitting unit comprises red, green, and blue light-emitting diodes.

3. The lighting apparatus as claimed in claim 2, wherein:
the driving pattern data comprise light-emitting duty values of the respective light-emitting elements, each corresponding to chromaticity and color temperatures, and
the controller drives the light-emitting elements according to the light-emitting duty values.

4. The lighting apparatus as claimed in claim 2, wherein:
the driving pattern data comprise light-emitting output values of the respective light-emitting elements, each corresponding to chromaticity and color temperatures, and
the controller drives the light-emitting elements according to the light-emitting output values.

5. The lighting apparatus as claimed in claim 3, wherein the chromaticity selection unit comprises:
a display unit for displaying a chromaticity diagram for setting the color temperatures and the chromaticity on a screen such that a user can select color coordinate values on the chromaticity diagram; and
an input unit for inputting the color coordinate values on the display unit and outputting input color coordinate values to the controller.

6. The lighting apparatus as claimed in claim 3, wherein the chromaticity selection unit comprises a touch screen in which a display unit for displaying a chromaticity diagram for setting the color temperatures and the chromaticity on a screen such that a user can select color coordinate values on the chromaticity diagram, and an input unit for, when the coordinate value on the chromaticity diagram provided on the display unit is selected, outputting the selected coordinate value to the controller are integrated.

7. The lighting apparatus as claimed in claim 3, wherein the controller comprises:
a control unit for extracting driving pattern data corresponding to a chromaticity and a color temperature, which are selected by the chromaticity selection unit, from the storage unit; and
a driver unit for controlling a light-emitting duty of a corresponding light-emitting element based on the driving pattern data output from the control unit.
